(19) United States
(12) Patent Application Publication
(10) Pub. No.: US 2014/0281276 A1
(43) Pub. Date: Sep. 18, 2014

(54) METHOD, APPARATUS, AND SYSTEM FOR LOW LATENCY COMMUNICATION

(71) Applicants: Pratik M. Marolia, Hillsboro, OR (US); Nagabhushan Chitlur, Portland, OR (US); Stephen S. Chang, Portland, OR (US)

(72) Inventors: Pratik M. Marolia, Hillsboro, OR (US); Nagabhushan Chitlur, Portland, OR (US); Stephen S. Chang, Portland, OR (US)

(21) Appl. No.: 13/827,695

(22) Filed: Mar. 14, 2013

(51) Int. Cl. G06F 12/08

(52) U.S. Cl. CPC G06F 12/0833
USPC 711/146

(57) ABSTRACT

A method, apparatus, computer program product, and computer readable medium to perform receipt of a snoop notification indicating a write to a memory address associated with a cache, determination that the snoop notification signifies receipt of a message based, at least in part, on the memory address, and performance of an operation based, at least in part, on the message is disclosed.

### FIELD

This disclosure pertains to computing system, and in particular (but not exclusively) to module low latency communication.

### BACKGROUND

As electronic apparatuses become more complex and ubiquitous in the everyday lives of users, more and more diverse requirements are placed upon them. To satisfy many of these requirements, many electronic apparatuses comprise many different devices, such as a CPU, a communication device, a graphics accelerator, etc. In many circumstances, there may be a large amount of communication between these devices. Furthermore, many users have high expectations regarding apparatus performance. Users are becoming less tolerant of waiting for operations to be performed by their apparatuses. In addition, many apparatuses are performing increasingly complex and burdensome tasks that may involve a large amount of inter-device communication. Therefore, there may be some communication between these devices that would benefit from rapid communication.

### BRIEF DESCRIPTION OF THE DRAWINGS

FIG. 1 illustrates an embodiment of a block diagram for a computing system including a multicore processor.

FIG. 2 is a block diagram illustrating components associated with caching according to at least one example embodiment.

FIG. 3 is a block diagram illustrating components associated with low latency communication according to at least one example embodiment.

FIGS. 4A-4C are diagrams illustrating message memory allocation associated with low latency communication according to at least one example embodiment.

FIGS. 5A-5B are flow diagrams illustrating activities associated with low latency communication according to at least one example embodiment.

FIGS. 6A-6C are flow diagrams illustrating activities associated with low latency communication according to at least one example embodiment.

FIG. 7 is a flow diagram illustrating activities associated with low latency communication according to at least one example embodiment.

FIG. 8 is a flow diagram illustrating activities associated with low latency communication according to at least one example embodiment.

FIGS. 9A-9B are flow diagrams illustrating activities associated with low latency communication according to at least one example embodiment.

FIG. 10 is a flow diagram illustrating activities associated with low latency communication according to at least one example embodiment.

FIG. 11 illustrates another embodiment of a block diagram for a computing system including a processor.

FIG. 12 illustrates another embodiment of a block diagram for a computing system.

### DETAILED DESCRIPTION

In the following description, numerous specific details are set forth, such as examples of specific types of processors and system configurations, specific hardware structures, specific architectural and micro architectural details, specific register configurations, specific instruction types, specific system components, specific measurements/heights, specific processor pipeline stages and operation etc. in order to provide a thorough understanding of the present invention. It will be apparent, however, to one skilled in the art that these specific details need not be employed to practice the present invention. In other instances, well known components or methods, such as specific and alternative processor architectures, specific logic circuits/code for described algorithms, specific firmware code, specific interconnect operation, specific logic configurations, specific manufacturing techniques and materials, specific compiler implementations, specific expression of algorithms in code, specific power down and gating techniques/logic and other specific operational details of computer system haven't been described in detail in order to avoid unnecessarily obscuring the present invention.

Although the following embodiments may be described with reference to energy conservation and energy efficiency in specific integrated circuits, such as in computing platforms or microprocessors, other embodiments are applicable to other types of integrated circuits and logic devices. Similar techniques and teachings of embodiments described herein may be applied to other types of circuits or semiconductor devices that may also benefit from better energy efficiency and energy conservation. For example, the disclosed embodiments are not limited to desktop computer systems or Ultrabooks™. And may be also used in other devices, such as handheld devices, tablets, other thin notebooks, systems on a chip (SOC) devices, and embedded applications. Some examples of handheld devices include cellular phones, Internet protocol devices, digital cameras, personal digital assistants (PDAs), and handheld PCs. Embedded applications typically include a microcontroller, a digital signal processor (DSP), a system on a chip, network computers (NetPC), set-top boxes, network hubs, wide area network (WAN) switches, or any other system that can perform the functions and operations taught below. Moreover, the apparatus', methods, and systems described herein are not limited to physical computing devices, but may also relate to software optimizations for energy conservation and efficiency. As will become readily apparent in the description below, the embodiments of methods, apparatus', and systems described herein (whether in reference to hardware, firmware, software, or a combination thereof) are vital to a ‘green technology’ future balanced with performance considerations.

As computing systems are advancing, the components therein are becoming more complex. As a result, the interconnect architecture to couple and communicate between the components is also increasing in complexity to ensure bandwidth requirements are met for optimal component operation. Furthermore, different market segments demand different aspects of interconnect architectures to suit the market's needs. For example, servers require higher performance, while the mobile ecosystem is sometimes able to sacrifice overall performance for power savings. Yet, it's a singular purpose of most fabrics to provide highest possible performance with maximum power saving. Below, a number of interconnects are discussed, which would potentially benefit from aspects of the invention described herein.

Referring to FIG. 1, an embodiment of a block diagram for a computing system including a multicore processor is depicted. Processor 100 includes any processor or processing device, such as a microprocessor, an embedded processor, a digital signal processor (DSP), a network processor, a handheld processor, an application processor, a co-processor, a system on a chip (SOC), or other device to execute code. Processor 100, in one embodiment, includes at least two cores—core 101 and 102, which may include asymmetric cores or symmetric cores (the illustrated embodiment). However, processor 100 may include any number of processing elements that may be symmetric or asymmetric.

In one embodiment, a processing element refers to hardware or logic to support a software thread. Examples of hardware processing elements include: a thread unit, a thread slot, a thread, a process unit, a context, a context unit, a logical processor, a hardware thread, a core, and/or any other element, which is capable of holding a state for a processor, such as an execution state or architectural state. In other words, a processing element, in one embodiment, refers to any hardware capable of being independently associated with code, such as a software thread, operating system, application, or other code. A physical processor (or processor socket) typically refers to an integrated circuit, which potentially includes any number of other processing elements, such as cores or hardware threads.

A core often refers to logic located on an integrated circuit capable of maintaining an independent architectural state, wherein each independently maintained architectural state is associated with at least some dedicated execution resources. In contrast to cores, a hardware thread typically refers to any logic located on an integrated circuit capable of maintaining an independent architectural state, wherein the independently maintained architectural states share access to execution resources. As can be seen, when certain resources are shared and others are dedicated to an architectural state, the line between the nomenclature of a hardware thread and core overlaps. Yet often, a core and a hardware thread are viewed by an operating system as individual logical processors, where the operating system is able to individually schedule operations on each logical processor.

Physical processor 100, as illustrated in FIG. 1, includes two cores—core 101 and 102. Here, core 101 and 102 are considered symmetric cores, i.e. cores with the same configurations, functional units, and/or logic. In another embodiment, core 101 includes an out-of-order processor core, while core 102 includes an in-order processor core. However, cores 101 and 102 may be individually selected from any type of core, such as a native core, a software managed core, a core adapted to execute a native Instruction Set Architecture (ISA), a core adapted to execute a translated Instruction Set Architecture (ISA), a co-designed core, or other known core. In a heterogeneous core environment (i.e. asymmetric cores), some form of translation, such a binary translation, may be utilized to schedule or execute code on one or both cores. Yet to further the discussion, the functional units illustrated in core 101 are described in further detail below, as the units in core 102 operate in a similar manner in the depicted embodiment.

As depicted, core 101 includes two hardware threads 101a and 101b, which may also be referred to as hardware thread slots 101a and 101b. Therefore, software entities, such as an operating system, in one embodiment potentially view processor 100 as four separate processors, i.e., four logical processors or processing elements capable of executing four software threads concurrently. As alluded to above, a first thread is associated with architecture state registers 101a, a second thread is associated with architecture state registers 101b, a third thread may be associated with architecture state registers 102a, and a fourth thread may be associated with architecture state registers 102b. Here, each of the architecture state registers (101a, 101b, 102a, and 102b) may be referred to as processing elements, thread slots, or thread units, as described above. As illustrated, architecture state registers 101a are replicated in architecture state registers 101b, so individual architecture states/contexts are capable of being stored for logical processor 101a and logical processor 101b. In core 101, other smaller resources, such as instruction pointers and renaming logic in allocator and renamer block 130 may also be replicated for threads 101a and 101b. Some resources, such as re-order buffers in reorder/retirement unit 135, ILTB 120, load/store buffers, and queues may be shared through partitioning. Other resources, such as general purpose internal registers, page-table base register(s), low-level data-cache and data-TLB 115, execution unit(s) 140, and portions of out-of-order unit 135 are potentially fully shared.

Processor 100 often includes other resources, which may be fully shared, shared through partitioning, or dedicated by/to processing elements. In FIG. 1, an embodiment of a purely exemplary processor with illustrative logical units/resources of a processor is illustrated. Note that a processor may include, or omit, any of these functional units, as well as include any other known functional units, logic, or firmware not depicted. As illustrated, core 101 includes a simplified, representative out-of-order (OOO) processor core. But an in-order processor may be utilized in different embodiments. The OOO core includes a branch target buffer 120 to predict branches to be executed/taken and an instruction-translation buffer (I-TLB) 120 to store address translation entries for instructions.

Core 101 further includes decode module 125 coupled to fetch unit 120 to decode fetched elements. Fetch logic, in one embodiment, includes individual sequencers associated with thread slots 101a, 101b, respectively. Usually core 101 is associated with a first ISA, which defines/specifies instructions executable on processor 100. Often machine code instructions that are part of the first ISA include a portion of the instruction (referred to as an opcode), which references/specifies an instruction or operation to be performed. Decode logic 125 includes circuitry that recognizes these instructions from their opcodes and passes the decoded instructions on in the pipeline for processing as defined by the first ISA. For example, as discussed in more detail below decoders 125, in one embodiment, include logic designed or adapted to recognize specific instructions, such as transactional instruction. As a result of the recognition by decoders 125, the architecture or core 101 takes specific, predefined actions to perform tasks associated with the appropriate instruction. It is important to note that any of the tasks, blocks, operations, and methods described herein may be performed in response to a single or multiple instructions; some of which may be new or old instructions. Note decoders 126, in one embodiment, recognize the same ISA (or a subset thereof). Alternatively, in a heterogeneous core environment, decoders 126 recognize a second ISA (either a subset of the first ISA or a distinct ISA).

In one example, allocator and renamer block 130 includes an allocator to reserve resources, such as register files to store instruction processing results. However, threads 101a and 101b are potentially capable of out-of-order execution, where allocator and renamer block 130 also reserves other resources, such as reorder buffers to track instruction results. Unit 130 may also include a register renamer to rename program/instruction reference registers to other registers internal to processor 100. Reorder/retirement unit 135 includes components, such as the reorder buffers mentioned above, load buffers, and store buffers, to support out-of-order execution and later in-order retirement of instructions executed out-of-order.

Scheduler and execution unit(s) block 140, in one embodiment, includes a scheduler unit to schedule instructions/operation on execution units. For example, a floating point instruction is scheduled on a port of an execution unit that has an available floating point execution unit. Register files associated with the execution units are also included to store information instruction processing results. Exemplary execution units include a floating point execution unit, an integer execution unit, a jump execution unit, a load execution unit, a store execution unit, and other known execution units.

Lower level data cache and data translation buffer (D-TLB) 150 are coupled to execution unit(s) 140. The data cache is to store recently used/operated on elements, such as data operands, which are potentially held in memory coherency states. The D-TLB is to store recent virtual/linear to physical address translations. As a specific example, a processor may include a page table structure to break physical memory into a plurality of virtual pages.

Here, cores 101 and 102 share access to higher-level or further-out cache, such as a second level cache associated with on-chip interface 110. Note that higher-level or further-out refers to cache levels increasing or getting further way from the execution unit(s). In one embodiment, higher-level cache is a last-level data cache—last cache in the memory hierarchy on processor 100—such as a second or third level data cache. However, higher level cache is not so limited, as it may be associated with or include an instruction cache. A trace cache—a type of instruction cache—instead may be coupled after decoder 125 to store recently decoded traces. Here, an instruction potentially refers to a macro-instruction (i.e. a general instruction recognized by the decoders), which may decode into a number of micro-instructions (micro-operations).

In the depicted configuration, processor 100 also includes on-chip interface module 110. Historically, a memory controller, which is described in more detail below, has been included in a computing system external to processor 100. In this scenario, on-chip interface 11 is to communicate with devices external to processor 100, such as system memory 175, a chipset (often including a memory controller hub to connect to memory 175 and an I/O controller hub to connect peripheral devices), a memory controller hub, a northbridge, or other integrated circuit. And in this scenario, bus 105 may include any known interconnect, such as multi-drop bus, a point-to-point interconnect, a serial interconnect, a parallel bus, a coherent (e.g. cache coherent) bus, a layered protocol architecture, a differential bus, and a GTL bus.

Memory 175 may be dedicated to processor 100 or shared with other devices in a system. Common examples of types of memory 175 include DRAM, SRAM, non-volatile memory (NV memory), and other known storage devices. Note that device 180 may include a graphic accelerator, processor or card coupled to a memory controller hub, data storage coupled to an I/O controller hub, a wireless transceiver, a flash device, an audio controller, a network controller, or other known device.

Recently however, as more logic and devices are being integrated on a single die, such as SOC, each of these devices may be incorporated on processor 100. For example in one embodiment, a memory controller hub is on the same package and/or die with processor 100. Here, a portion of the core (an on-core portion) 110 includes one or more controller(s) for interfacing with other devices such as memory 175 or a graphics device 180. The configuration including an interconnect and controllers for interfacing with such devices is often referred to as an on-core (or un-core configuration). As an example, on-chip interface 110 includes a ring interconnect for on-chip communication and a high-speed serial point-to-point link 105 for off-chip communication. Yet, in the SOC environment, even more devices, such as the network interface, co-processors, memory 175, graphics processor 180, and any other known computer devices/interface may be integrated on a single die or integrated circuit to provide small form factor with high functionality and low power consumption.

In one embodiment, processor 100 is capable of executing a compiler, optimization, and/or translator code 177 to compile, translate, and/or optimize application code 176 to support the apparatus and methods described herein or to interface therewith. A compiler often includes a program or set of programs to translate source text/code into target text/code. Usually, compilation of program/application code with a compiler is done in multiple phases and passes to transform hi-level programming language code into low-level machine or assembly language code. Yet, single pass compilers may still be utilized for simple compilation. A compiler may utilize any known compilation techniques and perform any known compiler operations, such as lexical analysis, preprocessing, parsing, semantic analysis, code generation, code transformation, and code optimization.

Larger compilers often include multiple phases, but most often these phases are included within two general phases: (1) a front-end, i.e. generally where syntactic processing, semantic processing, and some transformation/optimization may take place, and (2) a back-end, i.e. generally where analysis, transformations, optimizations, and code generation takes place. Some compilers refer to a middle, which illustrates the blurring of delineation between a front-end and back end of a compiler. As a result, reference to insertion, association, generation, or other operation of a compiler may take place in any of the aforementioned phases or passes, as well as any other known phases or passes of a compiler. As an illustrative example, a compiler potentially inserts operations, calls, functions, etc. in one or more phases of compilation, such as insertion of calls/operations in a front-end phase of compilation and then transformation of the calls/operations into lower-level code during a transformation phase. Note that during dynamic compilation, compiler code or dynamic optimization code may insert such operations/calls, as well as optimize the code for execution during runtime. As a specific illustrative example, binary code (already compiled code) may be dynamically optimized during runtime. Here, the program code may include the dynamic optimization code, the binary code, or a combination thereof.

Similar to a compiler, a translator, such as a binary translator, translates code either statically or dynamically to optimize and/or translate code. Therefore, reference to execution of code, application code, program code, or other software environment may refer to: (1) execution of a compiler program(s), optimization code optimizer, or translator either dynamically or statically, to compile program code, to maintain software structures, to perform other operations, to optimize code, or to translate code; (2) execution of main program code including operations/calls, such as application code that has been optimized/compiled; (3) execution of other program code, such as libraries, associated with the main program code to maintain software structures, to perform other software related operations, or to optimize code; or (4) a combination thereof.

FIG. 2 is a block diagram illustrating components associated with caching according to at least one example embodiment. The example of FIG. 2 is merely an example of components associated with caching, and does not limit the scope of the claims. For example, operations attributed to a component may vary, number of components may vary, composition of a component may vary, and/or the like. For example, in some example embodiments, operations attributable to one component of the example of FIG. 2 may be allocated to one or more other components.

In the example of FIG. 2, module 202 has cache 204, which relates to memory 206, and module 212 has cache 214, which relates to memory 206. Module 202 may be any component, such as a central processing unit (CPU), an embedded controller, a device, and/or the like. In at least one example embodiment, module 202 is a CPU, such as processor 1102 of FIG. 11. Module 212 may be any component, such as a CPU, an embedded controller, a device, and/or the like. In at least one example embodiment, module 212 is a device, such as wireless transceiver 1126 of FIG. 11, network controller 1134 of FIG. 11, audio controller 1136 of FIG. 11, and/or the like. In at least one example embodiment, module 212 is an accelerator, such as video card 1112 of FIG. 11, and/or the like. In at least one example embodiment, module 212 is an on-chip accelerator. Even though cache 204 is shown separately from module 202, in at least one example embodiment, cache 204 is comprised by module 202. Even though cache 214 is shown separately from module 212, in at least one example embodiment, cache 214 is comprised by module 212.

In circumstances where cache 204 and cache 214 relate to corresponding memory addresses, there are various cache coherence techniques that may be utilized to allow module 202 to sufficiently rely on the coherence of the data of cache 204, and for module 212 to sufficiently relay on coherence of the data of cache 214. For example, if module 202 writes data to a memory address that corresponds with a memory address related to cache 214, the coherence technique allows for operation of module 212 without referencing the data of the memory address as represented by the non-updated information of cache 214. For simplicity, caches 204 and 214 will be discussed generally as functional units, however, in at least one example embodiment, operations discussed pertaining to caches 204 and 214 may be attributable to a subpart of the cache, such as a cache controller, cache memory, and/or the like.

In at least one example embodiment, the components of FIG. 2 utilize a snooping cache coherency technique. In at least one example embodiment, a snooping cache coherence technique relates to a process where individual caches monitor address lines for accesses to memory locations that they have cached, such that when a write operation is observed to a location that a cache has a copy of, the cache controller invalidates its own copy of the snooped memory location. In at least one example embodiment, a snoop filter reduces the snooping traffic by maintaining a plurality of entries, each representing a cache line that may be owned by one or more nodes. When replacement of one of the entries is desired, the snoop filter may select, for replacement, an entry representing a cache line or lines owned by the fewest number of caches, for example as determined from a presence vector in each of the entries. A temporal or other type of algorithm may be used to refine the selection if more than one cache line is owned by the fewest number of nodes.

In at least one example embodiment, in circumstances where a cache relates to a memory address, the cache receives a snoop notification when another component performs a write to the memory address. In at least one example embodiment, snoop notification is a signal that provides an indication to the cache that the information stored at the memory location may have been written to, and that the information in the cache may no longer be a valid representation of the information stored at the memory address. For example, if cache 204 and cache 214 both relate to the same memory address, performance of a write by module 202 will cause a snoop notification to be sent to cache 214. Therefore, receipt of a snoop notification indicates a write to a memory address.

In at least one example embodiment, caching of a memory address is a prerequisite for receiving a snoop notification indicating a write to the memory address. For example, if a single module is reading from a memory address, a write to that memory address from the module will not cause a snoop notification. Management of the cache coherency technique may comprise monitoring which caches (i.e. which modules) are relying on a memory address. This reliance may be determined based on read and write activity. For example, if a module performs a read on the memory address, the management of the cache coherency technique may recognize the dependency of the cache on the memory address, for example by setting a shared bit associated with the memory address. Therefore, performing a write to the memory address causes enablement of a subsequent snoop notification associated with the next write performed to the memory address. Consequently, a module may cause enablement of a subsequent snoop notification by performing a read to the memory address.

FIG. 3 is a block diagram illustrating components associated with low latency communication according to at least one example embodiment. The example of FIG. 3 is merely an example of components associated with low latency communication, and does not limit the scope of the claims. For example, operations attributed to a component may vary, number of components may vary, composition of a component may vary, and/or the like. For example, in some example embodiments, operations attributable to one component of the example of FIG. 3 may be allocated to one or more other components.

As caching has become more prevalent, there have been many architectural and design advances that have resulted in high efficiency and low latency for caching and cache coherency mechanisms. For example, cache coherency signaling is often faster than communication by way of shared memory. Therefore, it may be desirable to utilize cache coherency techniques as a communication mechanism.

As described in FIGS. 11 and 12, in many systems, there is communication between a processor and a device, an accelerator, and/or the like. In many of these systems, it may be desirable to reduce latency associated with communication between these components. Some mechanisms to communicate between components involve writing to shared memory, sending messages by way of input/output cycles, etc. In some circumstances, the latency associated with such communication may be significantly higher than latency associated with cache coherency mechanisms.

Knowledge that a specific module, or set of modules, is performing the write to a specific address that causes the snoop notification provides an inference that receipt of a snoop notification signifies a write by the specific module or set of modules. Furthermore, if a different specific module, or set of modules, is monitoring (for example has cached) the specific address, writing to the specific memory address provides an inference that writing to the specific memory address will cause the different specific module or set of modules to receive the snoop notification. Relating back to FIG. 2, if a specific memory address is allocated for use by both module 202 and module 212, such that other modules do not write to the specific memory address, when a snoop notification is sent to cache 214, the snoop notification provides an inference that module 202 performed a write to the specific memory address. Likewise, when module 202 performs a write to the specific memory address, there is an inference that the write causes a snoop notification to be sent to cache 214. In at least one example embodiment, this inferential relationship may be leveraged to communicate between module 202 and module 212. For example, there may be a communication protocol based on utilization of cache coherency mechanisms and shared knowledge of memory references between a sending module and a receiving module.

The example of FIG. 3 illustrates low latency messaging and standard latency messaging in accordance with at least one example embodiment. The example of FIG. 2 shows sender 306 and receiver 304 in communication with memory 310. Sender 302 may be any component that sends communication to another component, such as a CPU, an embedded controller, a device, an integrated accelerator device, and/or the like. In at least one example embodiment, sender 306 is a CPU, such as processor 1102 of FIG. 11. Receiver 304 may be any component, such as a CPU, an embedded controller, a device, an integrated accelerator device and/or the like. In at least one example embodiment, receiver 304 is a device, such as wireless transceiver 1126 of FIG. 11, network controller 1134 of FIG. 11, audio controller 1136 of FIG. 11, and/or the like. In at least one example embodiment, receiver 304 is an accelerator, such as video card 1112 of FIG. 11, and/or the like. In at least one example embodiment, sender 302 comprises software 306. Software 306 may be any program that is executed by sender 302. In at least one example embodiment, software 302 may perform operations that involve communication with receiver 304. For example, there may be an operation that determines to send a message to receiver 304.

In the example of FIG. 3, memory 310 comprises memory mapped configuration (MMCFG) address space 314. MMCFG address space may relate to address space allocated for a shared memory interface. In at least one example embodiment, sender 302 may store information, as illustrated by interaction 332, such as a message data structure, to an address in MMFG address space to generate a cfgwrite command to receiver 304, as illustrated by interaction 334. In this manner, sender may send a message, represented by the message data structure, to receiver 304.

Even though the example of FIG. 3 illustrates only address space 312 and address space 314, it should be understood that illustrating these address spaces, without other address spaces, is for simplicity purposes and that memory 310 may comprise other address spaces not shown in FIG. 2. Therefore, the claims are not limited by the example of memory 310.

In at least one example embodiment, memory 310 comprises address space associated with cache based messaging, such as memory address space 400 of FIG. 4A, memory address space 430 of FIG. 4B, memory address space 460 of FIG. 4C, and/or the like. In at least one example embodiment, cache based message address space relates to address space that has been allocated for messaging as described hereinafter. In at least one example embodiment, sender 302 and receiver 304 are configured to utilize a cache coherency technique, similar as described regarding FIG. 2, with regards to address space 312. In at least one example embodiment, at least one of sender 302 or receiver 304 utilize a cache that includes address space 312 to utilize the cache coherency technique.

In at least one example embodiment, at least one of sender 302 or receiver 304 implement cache management signaling, absent cache memory, such that cache coherency information associated with address space 312 will be applied regarding the cache management signaling. For example, in absence of cache memory, the module may comprise a reading agent to perform reads to memory addresses within address space 312 and a monitoring agent to receive and act upon snoop notifications received in association with address space 312. For example, even though such a module has no cache to keep coherent with address space 312, the module may utilize a monitoring agent to receive snoop notification to be informed of snoop notifications that signify a write to a memory address comprised by address space 312. Furthermore, after receiving a snoop notification associated with a memory address, a receiver, such as receiver 304, may utilize a reading agent to enable receipt of a subsequent snoop notification associated with the memory address. For example, the reading agent may preclude exclusive ownership of the memory address by another component. For example the reading agent may perform a read to the memory address. In at least one example embodiment, the reading agent performs a read to the memory address under circumstances where receiver 304 has no regard for the information stored at the memory address. For example, receiver 304 may perform a read to the memory address without regard for the information retrieved by way to the read. Without limiting the claims in any way, at least one technical advantage associated with the receiver causing enablement of snoop notifications and receiving snoop notification is to allow the receiver to utilize the low latency benefits of the cache coherency system. For example, even if the receiver fails to include a cache, the receiver may be able to receive the low latency snoop notifications as a low latency communication mechanism. In this manner, a memory address may be associated with a cache from the perspective of the cache coherency mechanisms, even in the absence of actual cache memory.

In at least one example embodiment, address space 312 is allocated such that a memory address represents a massage. For example, a write to the memory address, without regard for the information written to the memory address, may represent a message to invoke an operation by receiver 304, such as a buffer flush. In at least one example embodiment, the memory address represents a message such that a write to the memory address by sender 302, such as shown in interaction 322, serves as a message to receiver 304 by way of a resulting snoop notification. Therefore, receiver 304 may interpret a snoop notification, itself, as a message based on the memory address associated with the snoop notification. In at least one example embodiment, receiver 304 determines that the snoop notification signifies receipt of a message based, at least in part, on the memory address. For example, receiver 304 may associate the memory address with the message. In such an example, a memory address may be associated with a message, and a different memory address may be associated with a different message, such that the receiver determines a snoop notification associated with the memory address to signify the message and determines a snoop notification associated with the different memory address to signify the different message. In at least one example embodiment, information indicating the association between a message and a memory address is referred to as message memory allocation information. Message memory allocation information may be based on predetermined information, such as information provided in a configuration file, determine at compile time, and/or the like. Message memory allocation information may be based on information received during operation of receiver 304, such as information received from sender 302. In at least one example embodiment, determination that a snoop notification signifies a message is based, at least in part, on correlation between the memory address and the message memory allocation information.

In at least one example embodiment, sender 302 sends message memory allocation information to receiver 304. For example, sender 302 may send message memory allocation information by way of MMCFG address space, input/output cycle communication, and/or the like. Receiver 304 may utilize the received message memory allocation information as, at least part of, a basis to determine that a snoop notification associated with a memory address signifies a particular message. In at least one example embodiment, sender 302 determines the message memory allocation information. For example, the message memory allocation information may be determined based on predetermined information, such as compile time information, a configuration file, and/or the like, or may be determined dynamically, such as by way of a request for allocation of address space 312. In at least one example embodiment, sender 302 causes allocation of memory 310 to address space 312. Allocation of memory 310 to address space 312 may relate to reserving address space 312 within memory 310 such that another program does not receive allocation of memory overlapping with address space 312.

In at least one example embodiment, the receiver may prepare for communication with the sender by way of causing enablement of receiving a subsequent snoop notification. For example, receiver 304 may preclude exclusive ownership of address space 312 by sender 302. In such an example, receiver 304 may perform reads to the memory addresses comprised by address space 312. Such reads may enable a subsequent write to a memory address comprised by address space 312 to cause a snoop notification associated with the memory address.

In at least one example embodiment, sender 302 may determine to send a message to receiver 304. Such determination may be caused by execution of software 306. For example software 306 may desire receiver 304 to perform an operation indicated by the message. In at least one example embodiment, determination to send the message causes sender to determine a memory address to trigger a snoop notification that signifies the message. For example, the sender may utilize message memory allocation information to determine which memory address is associated with the determined message, such that a write to the memory address will cause a snoop notification associated with the address to be sent to receiver 304. In at least one example embodiment, sender 302 performs a write to the memory address to cause the snoop notification to communicate the determined message. In this manner, the performance of the write, itself, may serve as sending the message. In at least one example embodiment, the information written to the memory address is not pertinent to the message. For example, the message may relate to a notification, a directive, and/or the like, that does not rely on any accompanying information, such as a message without any payload. Such a message may be utilized to invoke a known operation without conveying additional information to govern the operation. In at least one example embodiment, the determined message may have a message payload associated with the message. A message payload may relate to information that provides additional information regarding the message, such as a parameter. For example, the message may rely on a variable, a buffer, and/or the like. In such an example, the payload may comprise the variable, the buffer, and/or the like. In at least one example embodiment, sender 302 performs the write of the payload to the memory address cause the snoop notification to communicate the determined message.

Consequently, receiver 304 may perform an operation based, at least in part on the message conveyed by the snoop notification. The operation may pertain to any action that receiver 304 performs based on receipt of the message. For example, the operation may involve storing information, sending a signal to hardware, starting a set of operations, terminating a set of operations, and/or the like. In at least one example embodiment, operation is based on the message without regard for information stored in the memory address. For example, the message may relate to a notification, a directive, and/or the like, that does not rely on any accompanying information, such as a message without any payload. In at least one example embodiment, the message may have a message payload associated with the message. A message payload may relate to information that provides additional information regarding the message, such as a parameter. For example, the message may rely on a variable, a buffer, and/or the like. In such an example, the read to the memory address may provide the variable, the buffer, and/or the like.

In at least one example embodiment, it may be desirable to provide for operations associated with messages to be performed in a specific order. For example, sender 306 may perform a first write to serve as sending of a first message and perform a second write to serve as sending of a second message. In such an example, the sender may desire that the receiver performs an operation associated with the first message before performance of an operation associated with the second message. In at least one example embodiment, the sender may provide enablement of sequence preservation. In at least one example embodiment, the sender may provide message sequence information in the payload of a message. For instance, in the previously discussed example, the first message payload may comprise message sequence information indicating that the first message is associated with an ordering before the second message. For example, the first message payload may comprise a message sequence number that is lower that a message sequence number comprised by the second message payload. In at least one example embodiment, the sender may await acknowledgement of a message from the receiver before sending another message. In at least one example embodiment, the receiver may provide an acknowledgement by way of a message, a function call, and or the like. For example, a similar mechanism may be used to allow the sender to receive communication from the receiver. In at least one example embodiment, the sender enables receipt of a snoop notification associated with the memory address after performing a write to the memory address that signifies the sending of the message. In such an embodiment, after receiving the message, the receiver may perform a write to the memory address to serve as an acknowledgement to the received message. In such an embodiment, the sender may predicate sending of the other message on receipt of the snoop notification associated the acknowledgement.

In at least one example embodiment, a cache prefetch operation may cause a snoop notification that does not correspond to a write to the memory address from sender 302. For example, when sender 302 performs a write to a memory address, the write may cause a prefetch of information associated with a different memory address adjacent to the memory address. In such an example, the prefetch of the information at the different memory address may cause a snoop notification associated with the different memory address. It may be desirable to be able to avoid circumstances where the prefetch of the different memory address causes the sender to determine that the snoop notification associated with the prefetch indicates a message associated with the different memory address. Therefore, it may be desirable for the receiver to determine that the snoop notification was not caused by a write performed to the memory address. For example, the receiver may store the information associated with the memory address so that, upon receiving a later received snoop notification, the receiver may compare the stored information with information at the memory address after the later received snoop notification. In such circumstances, a lack of difference between the stored information and the information associated with the later received snoop notification is indicative of a snoop notification that was not caused by a write to the memory address. Under such circumstances, the receiver may determine that the snoop notification fails to signify receipt of a message.

Without limiting the scope of the claims in any way, at least one technical advantage associated with the communication represented by interactions 322 and 324 is a large reduction in latency over other forms of communication, such as the communication represented by interactions 332 and 334. For example, the communication represented by interactions 332 and 334 may relate to a latency time of 284 nanoseconds, and the communication represented by interactions 322 and 324 may relate to a latency time of 85 nanoseconds.

FIGS. 4A-4C are diagrams illustrating message memory allocation associated with low latency communication according to at least one example embodiment. The example of FIGS. 4A-4C are merely examples of message memory allocation, and does not limit the scope of the claims. For example, arrangement of messages may vary, number of messages may vary, memory space allocated to a message may vary, and/or the like.

In at least one example embodiment, the memory allocation examples of FIGS. 4A-4C may be represented by message memory allocation information. For example, message memory allocation information may indicate the relationship between a message and a memory address. In another example, the message memory allocation information may indicate message payload size of a message, if any. In at least one example embodiment, message memory allocation information provides correlation between a message and its associated memory address. For example, the message memory allocation information may be similar to a table, a map, a list, and/or the like.

The example of FIG. 4A illustrates message memory allocation 400 associated with messages 402, 404, 406, and 408. The example of message memory allocation 400 represents a memory allocation indicative of messages that have no payload or messages that have a single word payload. For example, the message memory allocation information may indicate that there is no message payload or the message payload is a single word.

The example of FIG. 4B illustrates message memory allocation 430 associated with messages 432, 434, 436, and 438. The example of message memory allocation 430 represents a memory allocation indicative of messages that have varying payload with respect to each other. For example, the message memory allocation information may indicate that message 432 has no message payload or a message payload that is a single word, that message 436 has a 2 word payload, and that messages 434 and 438 have 5 word payloads.

As described above, it may be desirable to avoid having a receiver determine that snoop notification caused by a cache prefetch signifies a message. In at least one example embodiment, the message memory allocation information designates memory addresses to be associated with messages such that there is only a single memory address associated with a message within a memory region that is the size of a prefetch page. The example of FIG. 4C illustrated an example of memory address space associated with message memory allocation information that designates a single memory address associated with a message within the span of a prefetch page. The example of FIG. 4C illustrates address space 460, which comprises memory addresses associated with messages 462, 464, 466, and 468, such that there is no more than a single memory address associated with a message within a single prefetch page span, as denoted by prefetch page spans 472, 474, 476, and 478. In such an embodiment, the message allocation information is configured to preclude the memory address being within a cache prefetch page of another address that is associated with a different message. Even though the example of FIG. 4C illustrates the memory address associated with the message being at the start of a prefetch page span, the memory address may be allocated at any memory address within the page span. In at least one example embodiment, such a memory allocation results in avoidance of a cache prefetch associated with a write to a memory address associated with a message causing a snoop notification based on a cache prefetch, for at least the reason that only a single memory address associated with a message is comprised within a prefetch page.

FIG. 5A is a flow diagram illustrating activities associated with receiving low latency communication according to at least one example embodiment. In at least one example embodiment, an apparatus comprises logic, at least a portion of which may be in hardware logic, such that the logic performs the activities of FIG. 5A. In at least one example embodiment, there is a set of operations that corresponds to the activities of FIG. 5A. An apparatus, for example processor 100 of FIG. 1, or a portion thereof, may utilize the set of operations. The apparatus may comprise means, including, for example processor 100 of FIG. 1, for performing such operations. In an example embodiment, an apparatus, for example processor 100 of FIG. 1, is transformed by having memory, for example system memory 175 of FIG. 1, comprising computer code configured to, working with a processor, for example processor 100 of FIG. 1, cause the apparatus to perform set of operations of FIG. 5A. In at least one example embodiment, the activities of FIG. 5B are performed by a device, an accelerator, and/or the like.

At block 502, the apparatus receives a snoop notification indicating a write to a memory address associated with a cache. The receiving of the snoop notification may be similar as described regarding FIGS. 2 and 3. As previously stated, even though the memory address is associated with a cache, there may be no cache memory associated with the memory address. For example, cache coherency mechanisms may be applied to the memory address absent any cache memory. At block 504, the apparatus determines that the snoop notification signifies receipt of a message based, at least in part, on the memory address. The determination and signification are similar as described regarding FIG. 3. At block 506, the apparatus performs an operation based, at least in part, on the message. The operation may be similar as described regarding FIG. 3. The operation may comprise other operations, other activities associated with the message, and/or the like.

FIG. 5B is a flow diagram illustrating activities associated with receiving low latency communication according to at least one example embodiment. In at least one example embodiment, an apparatus comprises logic, at least a portion of which may be in hardware logic, such that the logic performs the activities of FIG. 5B. In at least one example embodiment, there is a set of operations that corresponds to the activities of FIG. 5B. An apparatus, for example processor 100 of FIG. 1, or a portion thereof, may utilize the set of operations. The apparatus may comprise means, including, for example processor 100 of FIG. 1, for performing such operations. In an example embodiment, an apparatus, for example processor 100 of FIG. 1, is transformed by having memory, for example system memory 175 of FIG. 1, comprising computer code configured to, working with a processor, for example processor 100 of FIG. 1, cause the apparatus to perform set of operations of FIG. 5B. In at least one example embodiment, the activities of FIG. 5A are performed by a CPU.

At block 552, the apparatus determines to send a message. The determination to send the message may be similar as described regarding FIG. 3. At block 554, the apparatus determines a memory address to trigger a snoop notification that signifies a message. The determination of the memory address and the association with causation of a snoop notification that signifies the message may be similar as described regarding FIG. 3. At block 556, the apparatus performs a write to the memory address to cause the snoop notification to communicate the message. The write, the information written, and the causation of the snoop notification are similar as described regarding FIG. 3.

FIG. 6A is a flow diagram illustrating activities associated with receiving low latency communication according to at least one example embodiment. In at least one example embodiment, an apparatus comprises logic, at least a portion of which may be in hardware logic, such that the logic performs the activities of FIG. 6A. In at least one example embodiment, there is a set of operations that corresponds to the activities of FIG. 6A. An apparatus, for example processor 100 of FIG. 1, or a portion thereof, may utilize the set of operations. The apparatus may comprise means, including, for example processor 100 of FIG. 1, for performing such operations. In an example embodiment, an apparatus, for example processor 100 of FIG. 1, is transformed by having memory, for example system memory 175 of FIG. 1, comprising computer code configured to, working with a processor, for example processor 100 of FIG. 1, cause the apparatus to perform set of operations of FIG. 6A. In at least one example embodiment, the activities of FIG. 5B are performed by a device, an accelerator, and/or the like.

As described in FIG. 3, the sender may provide message memory allocation information to the sender to enable the use of the cache coherency mechanisms as a communication mechanism and to allow the sender to perform activities associated with preparation of such communication.

At block 602, the apparatus receives message memory allocation information, similar as describer regarding FIG. 3. In at least one example embodiment, the message memory allocation information indicates at least one memory address to associate with at least one message, similar as described regarding FIG. 3. At block 604, the apparatus causes enablement of a subsequent snoop notification, similar as described regarding FIG. 3. The snoop notification may be associated with a memory address designated by the message memory allocation information, similar as described regarding FIG. 3. At block 606, the apparatus receives a snoop notification indicating a write to a memory address associated with a cache, similar as described regarding block 502 of FIG. 5A. At block 608, the apparatus determines that the snoop notification signifies receipt of a message based, at least in part, on the memory address, similar as described regarding block 504 of FIG. 5A. In at least one example embodiment, determination that the snoop notification denotes receipt of the message is further based, at least in part, on correlation between the memory address and the message allocation information, similar as described regarding FIG. 3. At block 610, the apparatus performs an operation based, at least in part, on the message, similar as described regarding block 506 of FIG. 5A.

FIG. 6B is a flow diagram illustrating activities associated with receiving low latency communication according to at least one example embodiment. In at least one example embodiment, an apparatus comprises logic, at least a portion of which may be in hardware logic, such that the logic performs the activities of FIG. 6. In at least one example embodiment, there is a set of operations that corresponds to the activities of FIG. 6B. An apparatus, for example processor 100 of FIG. 1, or a portion thereof, may utilize the set of operations. The apparatus may comprise means, including, for example processor 100 of FIG. 1, for performing such operations. In an example embodiment, an apparatus, for example processor 100 of FIG. 1, is transformed by having memory, for example system memory 175 of FIG. 1, comprising computer code configured to, working with a processor, for example processor 100 of FIG. 1, cause the apparatus to perform set of operations of FIG. 6B. In at least one example embodiment, the activities of FIG. 6A are performed by a CPU.

As described in FIG. 3, the sender may perform allocation of the address space associated with message memory allocation information, for example to secure the memory space for use. In some circumstances, at least one memory address associated with the message memory allocation information may be already known to the receiver. For example, the memory address may be comprised in compile-time information, a configuration file, and/or the like.

At block 652, the apparatus determines message memory allocation information, similar as described regarding FIG. 3. In at least one example embodiment, the message memory allocation information indicates, at least, that at least one memory address is associated with at least one message, similar as described regarding FIG. 3. At block 654, the apparatus causes allocation of at least one memory address based, at least in part, on the memory allocation information, similar as described regarding FIG. 3. At block 656, the apparatus determines to send a message, similar as described regarding block 552 of FIG. 5B. At block 658, the apparatus determines a memory address to trigger a snoop notification that signifies a message, similar as described regarding block 554 of FIG. 5B. In at least one example embodiment, determination of the message memory address to trigger a snoop notification is based, at least in part, on the memory allocation information. At block 660, the apparatus performs a write to the memory address to cause the snoop notification to communicate the message, similar as described regarding block 556 of FIG. 5B.

FIG. 6C is a flow diagram illustrating activities associated with receiving low latency communication according to at least one example embodiment. In at least one example embodiment, an apparatus comprises logic, at least a portion of which may be in hardware logic, such that the logic performs the activities of FIG. 6C. In at least one example embodiment, there is a set of operations that corresponds to the activities of FIG. 6C. An apparatus, for example processor 100 of FIG. 1, or a portion thereof, may utilize the set of operations. The apparatus may comprise means, including, for example processor 100 of FIG. 1, for performing such operations. In an example embodiment, an apparatus, for example processor 100 of FIG. 1, is transformed by having memory, for example system memory 175 of FIG. 1, comprising computer code configured to, working with a processor, for example processor 100 of FIG. 1, cause the apparatus to perform set of operations of FIG. 6C. In at least one example embodiment, the activities of FIG. 6A are performed by a CPU.

As described in FIG. 3, the sender may provide message memory allocation information to the sender to enable the use of the cache coherency mechanisms as a communication mechanism and to allow the sender to perform activities associated with preparation of such communication.

At block 672, the apparatus determines message memory allocation information, similar as described regarding block 652 of FIG. 6B. At block 674, the apparatus causes allocation of at least one memory address based, at least in part, on the memory allocation information, similar as described regarding block 654 of FIG. 6B. At block 676, the apparatus sends the message memory allocation information to a receiver, similar as described regarding FIG. 3. At block 678, the apparatus determines to send a message, similar as described regarding block 552 of FIG. 5B. At block 680, the apparatus determines a memory address to trigger a snoop notification that signifies a message, similar as described regarding block 554 of FIG. 5B. At block 682, the apparatus performs a write to the memory address to cause the snoop notification to communicate the message, similar as described regarding block 556 of FIG. 5B.

FIG. 7 is a flow diagram illustrating activities associated with low latency communication according to at least one example embodiment. In at least one example embodiment, an apparatus comprises logic, at least a portion of which may be in hardware logic, such that the logic performs the activities of FIG. 7. In at least one example embodiment, there is a set of operations that corresponds to the activities of FIG. 7. An apparatus, for example processor 100 of FIG. 1, or a portion thereof, may utilize the set of operations. The apparatus may comprise means, including, for example processor 100 of FIG. 1, for performing such operations. In an example embodiment, an apparatus, for example processor 100 of FIG. 1, is transformed by having memory, for example system memory 175 of FIG. 1, comprising computer code configured to, working with a processor, for example processor 100 of FIG. 1, cause the apparatus to perform set of operations of FIG. 7. In at least one example embodiment, the activities of FIG. 6C are performed by a device, an accelerator, and/or the like.

As described in FIG. 3, in some circumstances, after receiving a snoop notification indicating a write to a memory address, it may be desirable to cause enablement of a subsequent snoop notification. For example, in at least some cache coherency mechanisms, failure to cause such enablement may result in failure to receive a subsequent snoop notification indicating a write to the memory address.

At block 702, the apparatus receives a snoop notification indicating a write to a memory address associated with a cache, similar as described regarding block 502 of FIG. 5A. At block 704, the apparatus determines that the snoop notification signifies receipt of a message based, at least in part, on the memory address, similar as described regarding block 504 of FIG. 5A. At block 706, the apparatus performs an operation based, at least in part, on the message, similar as described regarding block 506 of FIG. 5A. At block 708, the apparatus causes enablement of a subsequent snoop notification, similar as described regarding block 604 of FIG. 6A. In at least one example embodiment, the enablement may comprise reading from the memory address. In circumstances where the operation performed based on the message is determined without regard for any information stored at the memory address, for example if the message does not have a payload, the operation may be performed prior to causation of enablement of a subsequent snoop notification. Without limiting the claims in any way, at least one technical advantage of such ordering may be to reduce latency associated with initiation of the operation by the receiver. This technical advantage may be increased in circumstances where the operation relates to an operation that may be performed in parallel with causation of enablement of the subsequent snoop notification, for example, an operation invoking a hardware operation.

FIG. 8 is a flow diagram illustrating activities associated with low latency communication according to at least one example embodiment. In at least one example embodiment, an apparatus comprises logic, at least a portion of which may be in hardware logic, such that the logic performs the activities of FIG. 8. In at least one example embodiment, there is a set of operations that corresponds to the activities of FIG. 8. An apparatus, for example processor 100 of FIG. 1, or a portion thereof, may utilize the set of operations. The apparatus may comprise means, including, for example processor 100 of FIG. 1, for performing such operations. In an example embodiment, an apparatus, for example processor 100 of FIG. 1, is transformed by having memory, for example system memory 175 of FIG. 1, comprising computer code configured to, working with a processor, for example processor 100 of FIG. 1, cause the apparatus to perform set of operations of FIG. 8. In at least one example embodiment, the activities of FIG. 6C are performed by a device, an accelerator, and/or the like.

In at least some circumstances, it may be desirable to perform enablement of subsequent snoop notifications prior to performing an operation based on a message. For example, the causation of enablement of the subsequent snoop notification may comprise performance of a read to the memory address. In such circumstances, the message may relate to a payload associated with information written to the memory address. Therefore, in such circumstances, it may be desirable to read to the memory address to serve the function of both, obtaining the message payload, and to cause enablement of the subsequent snoop notification.

At block 802, the apparatus receives a snoop notification indicating a write to a memory address associated with a cache, similar as described regarding block 502 of FIG. 5A. At block 804, the apparatus determines that the snoop notification signifies receipt of a message based, at least in part, on the memory address, similar as described regarding block 504 of FIG. 5A. At block 806, the apparatus performs a read of the memory address, similar as described regarding FIG. 3. At block 808, the apparatus performs an operation based, at least in part, on the message, similar as described regarding block 506 of FIG. 5A.

FIG. 9A is a flow diagram illustrating activities associated with receiving low latency communication according to at least one example embodiment. In at least one example embodiment, an apparatus comprises logic, at least a portion of which may be in hardware logic, such that the logic performs the activities of FIG. 9A. In at least one example embodiment, there is a set of operations that corresponds to the activities of FIG. 9A. An apparatus, for example processor 100 of FIG. 1, or a portion thereof, may utilize the set of operations. The apparatus may comprise means, including, for example processor 100 of FIG. 1, for performing such operations. In an example embodiment, an apparatus, for example processor 100 of FIG. 1, is transformed by having memory, for example system memory 175 of FIG. 1, comprising computer code configured to, working with a processor, for example processor 100 of FIG. 1, cause the apparatus to perform set of operations of FIG. 9A. In at least one example embodiment, the activities of FIG. 6C are performed by a device, an accelerator, and/or the like.

As described in FIG. 3, it may be desirable to take measures to allow for messages to be handled by the receiver in a specified order. As described in FIG. 3, in at least one example embodiment, the receiver may signal an acknowledgement to the sender by way of writing to the memory address associated with the received message.

At block 902, the apparatus receives a snoop notification indicating a write to a memory address associated with a cache, similar as described regarding block 502 of FIG. 5A. At block 904, the apparatus determines that the snoop notification signifies receipt of a message based, at least in part, on the memory address, similar as described regarding block 504 of FIG. 5A. At block 906, the apparatus performs an operation based, at least in part, on the message, similar as described regarding block 506 of FIG. 5A. At block 908, the apparatus performs a write to the memory address, similar as described regarding FIG. 3. In at least one example embodiment, the write serves as an acknowledgement of the message to the sender by way of causation of a snoop notification, to the sender, associated with the memory address.

FIG. 9B is a flow diagram illustrating activities associated with receiving low latency communication according to at least one example embodiment. In at least one example embodiment, an apparatus comprises logic, at least a portion of which may be in hardware logic, such that the logic performs the activities of FIG. 9B. In at least one example embodiment, there is a set of operations that corresponds to the activities of FIG. 9B. An apparatus, for example processor 100 of FIG. 1, or a portion thereof, may utilize the set of operations. The apparatus may comprise means, including, for example processor 100 of FIG. 1, for performing such operations. In an example embodiment, an apparatus, for example processor 100 of FIG. 1, is transformed by having memory, for example system memory 175 of FIG. 1, comprising computer code configured to, working with a processor, for example processor 100 of FIG. 1, cause the apparatus to perform set of operations of FIG. 9B. In at least one example embodiment, the activities of FIG. 9A are performed by a CPU.

As described in FIG. 3, it may be desirable to take measures to allow for messages to be handled by the receiver in a specified order. As described in FIG. 3, in at least one example embodiment, the receiver may signal an acknowledgement to the sender by way of writing to the memory address associated with the received message.

At block 952, the apparatus determines to send a message, similar as described regarding block 552 of FIG. 5B. At block 954, the apparatus determines a memory address to trigger a snoop notification that signifies a message, similar as described regarding block 554 of FIG. 5B. At block 956, the apparatus performs a write to the memory address to cause the snoop notification to communicate the message, similar as described regarding block 556 of FIG. 5B. At block 958, the apparatus determines to send another message, similar as described regarding block 952. In at least one example embodiment, the other message is to be handled by the receiver after the message is handled. At block 960, the apparatus determines a memory address to trigger a snoop notification that signifies the other message, similar as described regarding block 954. At block 962, the apparatus receives an indication of an acknowledgement associated with the message, similar as described regarding FIG. 3. In at least one example embodiment, the snoop notification is interpreted as an acknowledgement of the message from the receiver. At block 964, the apparatus performs a write to the memory address to cause the snoop notification to communicate the message, similar as described regarding block 956. In at least one example embodiment, performance of block 964 is based, at least in part, on receipt of the snoop notification of block 962. For example, performance of block 964 may be predicated upon receipt of the snoop notification of block 962.

FIG. 10 is a flow diagram illustrating activities associated with low latency communication according to at least one example embodiment. In at least one example embodiment, an apparatus comprises logic, at least a portion of which may be in hardware logic, such that the logic performs the activities of FIG. 10. In at least one example embodiment, there is a set of operations that corresponds to the activities of FIG. 10. An apparatus, for example processor 100 of FIG. 1, or a portion thereof, may utilize the set of operations. The apparatus may comprise means, including, for example processor 100 of FIG. 1, for performing such operations. In an example embodiment, an apparatus, for example processor 100 of FIG. 1, is transformed by having memory, for example system memory 175 of FIG. 1, comprising computer code configured to, working with a processor, for example processor 100 of FIG. 1, cause the apparatus to perform set of operations of FIG. 10. In at least one example embodiment, the activities of FIG. 6C are performed by a device, an accelerator, and/or the like.

As described in FIG. 3, it may be desirable to differentiate a snoop notification that was caused by a write to the memory address from a snoop notification that was caused by an operation other than a write to the memory address, such as a cache prefetch.

At block 1002, the apparatus receives a snoop notification indicating a write to a memory address associated with a cache, similar as described regarding block 502 of FIG. 5A. At block 1004, the apparatus determines that the snoop notification was caused by a write performed to the memory address, similar as described regarding FIG. 3. At block 1006, the apparatus determines that the snoop notification signifies receipt of a message based, at least in part, on the memory address, similar as described regarding block 504 of FIG. 5A. In at least one example embodiment, performance of block 1006 is based, at least in part, on the determination of block 1004 that a write was performed to the memory address. For example, performance of block 1006 may be predicated upon the determination of block 1004 that a write was performed to the memory address. At block 1008, the apparatus performs an operation based, at least in part, on the message, similar as described regarding block 506 of FIG. 5A.

Note that the apparatus', methods', and systems described above may be implemented in any electronic device or system as aforementioned. As specific illustrations, the figures below provide exemplary systems for utilizing the invention as described herein. As the systems below are described in more detail, a number of different interconnects are disclosed, described, and revisited from the discussion above. And as is readily apparent, the advances described above may be applied to any of those interconnects, fabrics, or architectures.

Turning to FIG. 11, a block diagram of an exemplary computer system formed with a processor that includes execution units to execute an instruction, where one or more of the interconnects implement one or more features in accordance with one embodiment of the present invention is illustrated. System 1100 includes a component, such as a processor 1102 to employ execution units including logic to perform algorithms for process data, in accordance with the present invention, such as in the embodiment described herein. System 1100 is representative of processing systems based on the PENTIUM III™, PENTIUM 4™, Xeon™, Itanium, XScale™ and/or StrongARM™ microprocessors available from Intel Corporation of Santa Clara, Calif., although other systems (including PCs having other microprocessors, engineering workstations, set-top boxes and the like) may also be used. In one embodiment, sample system 1100 executes a version of the WINDOWS™ operating system available from Microsoft Corporation of Redmond, Wash., although other operating systems (UNIX and Linux for example), embedded software, and/or graphical user interfaces, may also be used. Thus, embodiments of the present invention are not limited to any specific combination of hardware circuitry and software.

Embodiments are not limited to computer systems. Alternative embodiments of the present invention can be used in other devices such as handheld devices and embedded applications. Some examples of handheld devices include cellular phones, Internet Protocol devices, digital cameras, personal digital assistants (PDAs), and handheld PCs. Embedded applications can include a micro controller, a digital signal processor (DSP), system on a chip, network computers (NetPC), set-top boxes, network hubs, wide area network (WAN) switches, or any other system that can perform one or more instructions in accordance with at least one embodiment.

In this illustrated embodiment, processor 1102 includes one or more execution units 1108 to implement an algorithm that is to perform at least one instruction. One embodiment may be described in the context of a single processor desktop or server system, but alternative embodiments may be included in a multiprocessor system. System 1100 is an example of a ‘hub’ system architecture. The computer system 1100 includes a processor 1102 to process data signals. The processor 1102, as one illustrative example, includes a complex instruction set computer (CISC) microprocessor, a reduced instruction set computing (RISC) microprocessor, a very long instruction word (VLIW) microprocessor, a processor implementing a combination of instruction sets, or any other processor device, such as a digital signal processor, for example. The processor 1102 is coupled to a processor bus 1110 that transmits data signals between the processor 1102 and other components in the system 1100. The elements of system 1100 (e.g. graphics accelerator 1112, memory controller hub 1116, memory 1120, I/O controller hub 1124, wireless transceiver 1126, Flash BIOS 1128, Network controller 1134, Audio controller 1136, Serial expansion port 1138, I/O controller 1140, etc.) perform their conventional functions that are well known to those familiar with the art.

In one embodiment, the processor 1102 includes a Level 1 (L1) internal cache memory 1104. Depending on the architecture, the processor 1102 may have a single internal cache or multiple levels of internal caches. Other embodiments include a combination of both internal and external caches depending on the particular implementation and needs. Register file 1106 is to store different types of data in various registers including integer registers, floating point registers, vector registers, banked registers, shadow registers, checkpoint registers, status registers, and instruction pointer register.

Execution unit 1108, including logic to perform integer and floating point operations, also resides in the processor 1102. The processor 1102, in one embodiment, includes a microcode (ucode) ROM to store microcode, which when executed, is to perform algorithms for certain macroinstructions or handle complex scenarios. Here, microcode is potentially updateable to handle logic bugs/fixes for processor 1102. For one embodiment, execution unit 1108 includes logic to handle a packed instruction set 1109. By including the packed instruction set 1109 in the instruction set of a general-purpose processor 1102, along with associated circuitry to execute the instructions, the operations used by many multimedia applications may be performed using packed data in a general-purpose processor 1102. Thus, many multimedia applications are accelerated and executed more efficiently by using the full width of a processor's data bus for performing operations on packed data. This potentially eliminates the need to transfer smaller units of data across the processor's data bus to perform one or more operations, one data element at a time.

Alternate embodiments of an execution unit 1108 may also be used in micro controllers, embedded processors, graphics devices, DSPs, and other types of logic circuits. System 1100 includes a memory 1120. Memory 1120 includes a dynamic random access memory (DRAM) device, a static random access memory (SRAM) device, flash memory device, or other memory device. Memory 1120 stores instructions and/or data represented by data signals that are to be executed by the processor 1102.

Note that any of the aforementioned features or aspects of the invention may be utilized on one or more interconnect illustrated in FIG. 11. For example, an on-die interconnect (ODI), which is not shown, for coupling internal units of processor 1102 implements one or more aspects of the invention described above. Or the invention is associated with a processor bus 1110 (e.g. Intel Quick Path Interconnect (QPI) or other known high performance computing interconnect), a high bandwidth memory path 1118 to memory 1120, a point-to-point link to graphics accelerator 1112 (e.g. a Peripheral Component Interconnect express (PCIe) compliant fabric), a controller hub interconnect 1122, an I/O or other interconnect (e.g. USB, PCI, PCIe) for coupling the other illustrated components. Some examples of such components include the audio controller 1136, firmware hub (flash BIOS) 1128, wireless transceiver 1126, data storage 1124, legacy I/O controller 1110 containing user input and keyboard interfaces 1142, a serial expansion port 1138 such as Universal Serial Bus (USB), and a network controller 1134. The data storage device 1124 can comprise a hard disk drive, a floppy disk drive, a CD-ROM device, a flash memory device, or other mass storage device.

Turning next to FIG. 12, an embodiment of a system on-chip (SOC) design in accordance with the inventions is depicted. As a specific illustrative example, SOC 1200 is included in user equipment (UE). In one embodiment, UE refers to any device to be used by an end-user to communicate, such as a hand-held phone, smartphone, tablet, ultra-thin notebook, notebook with broadband adapter, or any other similar communication device. Often a UE connects to a base station or node, which potentially corresponds in nature to a mobile station (MS) in a GSM network.

Here, SOC 1200 includes 2 cores—1206 and 1207. Similar to the discussion above, cores 1206 and 1207 may conform to an Instruction Set Architecture, such as an Intel® Architecture Core™-based processor, an Advanced Micro Devices, Inc. (AMD) processor, a MIPS-based processor, an ARM-based processor design, or a customer thereof, as well as their licensees or adopters. Cores 1206 and 1207 are coupled to cache control 1208 that is associated with bus interface unit 1209 and L2 cache 1210 to communicate with other parts of system 1200. Interconnect 1210 includes an on-chip interconnect, such as an IOSF, AMBA, or other interconnect discussed above, which potentially implements one or more aspects of the described invention.

Interface 1210 provides communication channels to the other components, such as a Subscriber Identity Module (SIM) 1230 to interface with a SIM card, a boot rom 1235 to hold boot code for execution by cores 1206 and 1207 to initialize and boot SOC 1200, a SDRAM controller 1240 to interface with external memory (e.g. DRAM 1260), a flash controller 1245 to interface with non-volatile memory (e.g. Flash 1265), a peripheral control Q1650 (e.g. Serial Peripheral Interface) to interface with peripherals, video codecs 1220 and Video interface 1225 to display and receive input (e.g. touch enabled input), GPU 1215 to perform graphics related computations, etc. Any of these interfaces may incorporate aspects of the invention described herein.

In addition, the system illustrates peripherals for communication, such as a Bluetooth module 1270, 3G modem 1275, GPS 1285, and WiFi 1285. Note as stated above, a UE includes a radio for communication. As a result, these peripheral communication modules are not all required. However, in a UE some form a radio for external communication is to be included.

While the present invention has been described with respect to a limited number of embodiments, those skilled in the art will appreciate numerous modifications and variations therefrom. It is intended that the appended claims cover all such modifications and variations as fall within the true spirit and scope of this present invention.

A design may go through various stages, from creation to simulation to fabrication. Data representing a design may represent the design in a number of manners. First, as is useful in simulations, the hardware may be represented using a hardware description language or another functional description language. Additionally, a circuit level model with logic and/or transistor gates may be produced at some stages of the design process. Furthermore, most designs, at some stage, reach a level of data representing the physical placement of various devices in the hardware model. In the case where conventional semiconductor fabrication techniques are used, the data representing the hardware model may be the data specifying the presence or absence of various features on different mask layers for masks used to produce the integrated circuit. In any representation of the design, the data may be stored in any form of a machine readable medium. A memory or a magnetic or optical storage such as a disc may be the machine readable medium to store information transmitted via optical or electrical wave modulated or otherwise generated to transmit such information. When an electrical carrier wave indicating or carrying the code or design is transmitted, to the extent that copying, buffering, or re-transmission of the electrical signal is performed, a new copy is made. Thus, a communication provider or a network provider may store on a tangible, machine-readable medium, at least temporarily, an article, such as information encoded into a carrier wave, embodying techniques of embodiments of the present invention.

A module as used herein refers to any combination of hardware, software, and/or firmware. As an example, a module includes hardware, such as a micro-controller, associated with a non-transitory medium to store code adapted to be executed by the micro-controller. Therefore, reference to a module, in one embodiment, refers to the hardware, which is specifically configured to recognize and/or execute the code to be held on a non-transitory medium. Furthermore, in another embodiment, use of a module refers to the non-transitory medium including the code, which is specifically adapted to be executed by the microcontroller to perform predetermined operations. And as can be inferred, in yet another embodiment, the term module (in this example) may refer to the combination of the microcontroller and the non-transitory medium. Often module boundaries that are illustrated as separate commonly vary and potentially overlap. For example, a first and a second module may share hardware, software, firmware, or a combination thereof, while potentially retaining some independent hardware, software, or firmware. In one embodiment, use of the term logic includes hardware, such as transistors, registers, or other hardware, such as programmable logic devices.

Use of the phrase ‘to’ or ‘configured to,’ in one embodiment, refers to arranging, putting together, manufacturing, offering to sell, importing and/or designing an apparatus, hardware, logic, or element to perform a designated or determined task. In this example, an apparatus or element thereof that is not operating is still ‘configured to’ perform a designated task if it is designed, coupled, and/or interconnected to perform said designated task. As a purely illustrative example, a logic gate may provide a 0 or a 1 during operation. But a logic gate ‘configured to’ provide an enable signal to a clock does not include every potential logic gate that may provide a 1 or 0. Instead, the logic gate is one coupled in some manner that during operation the 1 or 0 output is to enable the clock. Note once again that use of the term ‘configured to’ does not require operation, but instead focus on the latent state of an apparatus, hardware, and/or element, where in the latent state the apparatus, hardware, and/or element is designed to perform a particular task when the apparatus, hardware, and/or element is operating.

Furthermore, use of the phrases ‘capable of/to,’ and or ‘operable to,’ in one embodiment, refers to some apparatus, logic, hardware, and/or element designed in such a way to enable use of the apparatus, logic, hardware, and/or element in a specified manner. Note as above that use of to, capable to, or operable to, in one embodiment, refers to the latent state of an apparatus, logic, hardware, and/or element, where the apparatus, logic, hardware, and/or element is not operating but is designed in such a manner to enable use of an apparatus in a specified manner.

A value, as used herein, includes any known representation of a number, a state, a logical state, or a binary logical state. Often, the use of logic levels, logic values, or logical values is also referred to as 1's and 0's, which simply represents binary logic states. For example, a 1 refers to a high logic level and 0 refers to a low logic level. In one embodiment, a storage cell, such as a transistor or flash cell, may be capable of holding a single logical value or multiple logical values. However, other representations of values in computer systems have been used. For example the decimal number ten may also be represented as a binary value of 1010 and a hexadecimal letter A. Therefore, a value includes any representation of information capable of being held in a computer system.

Moreover, states may be represented by values or portions of values. As an example, a first value, such as a logical one, may represent a default or initial state, while a second value, such as a logical zero, may represent a non-default state. In addition, the terms reset and set, in one embodiment, refer to a default and an updated value or state, respectively. For example, a default value potentially includes a high logical value, i.e. reset, while an updated value potentially includes a low logical value, i.e. set. Note that any combination of values may be utilized to represent any number of states.

The embodiments of methods, hardware, software, firmware or code set forth above may be implemented via instructions or code stored on a machine-accessible, machine readable, computer accessible, or computer readable medium which are executable by a processing element. A non-transitory machine-accessible/readable medium includes any mechanism that provides (i.e., stores and/or transmits) information in a form readable by a machine, such as a computer or electronic system. For example, a non-transitory machine-accessible medium includes random-access memory (RAM), such as static RAM (SRAM) or dynamic RAM (DRAM); ROM; magnetic or optical storage medium; flash memory devices; electrical storage devices; optical storage devices; acoustical storage devices; other form of storage devices for holding information received from transitory (propagated) signals (e.g., carrier waves, infrared signals, digital signals); etc, which are to be distinguished from the non-transitory mediums that may receive information there from.

Instructions used to program logic to perform embodiments of the invention may be stored within a memory in the system, such as DRAM, cache, flash memory, or other storage. Furthermore, the instructions can be distributed via a network or by way of other computer readable media. Thus a machine-readable medium may include any mechanism for storing or transmitting information in a form readable by a machine (e.g., a computer), but is not limited to, floppy diskettes, optical disks, Compact Disc, Read-Only Memory (CD-ROMs), and magneto-optical disks, Read-Only Memory (ROMs), Random Access Memory (RAM), Erasable Programmable Read-Only Memory (EPROM), Electrically Erasable Programmable Read-Only Memory (EEPROM), magnetic or optical cards, flash memory, or a tangible, machine-readable storage used in the transmission of information over the Internet via electrical, optical, acoustical or other forms of propagated signals (e.g., carrier waves, infrared signals, digital signals, etc.). Accordingly, the computer-readable medium includes any type of tangible machine-readable medium suitable for storing or transmitting electronic instructions or information in a form readable by a machine (e.g., a computer).

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

In the foregoing specification, a detailed description has been given with reference to specific exemplary embodiments. It will, however, be evident that various modifications and changes may be made thereto without departing from the broader spirit and scope of the invention as set forth in the appended claims. The specification and drawings are, accordingly, to be regarded in an illustrative sense rather than a restrictive sense. Furthermore, the foregoing use of embodiment and other exemplarily language does not necessarily refer to the same embodiment or the same example, but may refer to different and distinct embodiments, as well as potentially the same embodiment.

The following examples pertain to embodiments in accordance with this Specification. One or more embodiments may provide an apparatus, a system, a machine readable storage, a machine readable medium, and a method for receiving a snoop notification indicating a write to a memory address associated with a cache, determining that the snoop notification signifies receipt of a message based, at least in part, on the memory address, and performing an operation based, at least in part, on the message.

One or more example embodiments further provide causation of a subsequent snoop notification based, at least in part, on determination that the snoop notification signifies the message.

In at least one example embodiment, causation of subsequent snoop notifications comprises performing a read of the memory address.

In at least one example embodiment, receipt of the snoop notification is performed by a monitoring agent.

One or more example embodiments further provide receiving message memory allocation information, such that determination that the snoop notification denotes receipt of the message is further based, at least in part, on correlation between the memory address and the message memory allocation information.

In at least one example embodiment, the operation is based, at least in part, on the message without regard for information stored at the memory address.

In at least one example embodiment, the operation is based, at least in part, on the message and information stored in association with the memory address.

One or more example embodiments further provide performance of a write to the memory address to acknowledge receipt of the message.

In at least one example embodiment, determination that the snoop notification signifies a message is further based, at least in part, on determination that the snoop notification was not caused by a cache prefetch.

In at least one example embodiment, determination that the snoop notification was not caused by the cache prefetch comprises determining that a write was performed at the memory address.

One or more embodiments may provide an apparatus, a machine readable storage, a machine readable storage medium, and a method for determining to send a message, determining a memory address to trigger a snoop notification that signifies the message, and performing a write to the memory address to cause the snoop notification to communicate the message.

In at least one example embodiment, information written to the memory address is not pertinent to the message.

One or more example embodiments further provide determining message payload information, wherein performance of the write to the memory address comprises performance of the write of the message payload information to the memory address.

One or more example embodiments further provide determining message memory allocation information that indicates, at least, that the memory address is associated with the message.

In at least one example embodiment, determination of the message memory address to trigger a snoop notification is based, at least in part, on the memory allocation information.

One or more example embodiments further provide sending the message memory allocation information.

In at least one example embodiment, the message allocation information is configured to preclude the memory address being within a cache prefetch page of another address that is associated with a different message.

One or more example embodiments further provide determining to send another message, such that the other message is received subsequent to the message, determining another memory address to trigger a snoop notification that signifies the other message, receiving a snoop notification associated with the memory address, and performing a write to the other memory address to cause the snoop notification to communicate the other message, based at least in part on receipt of the snoop notification associated with the memory address.

What is claimed is:

1. An apparatus comprising:
logic to:
determine to send a message;
determine a memory address to trigger a snoop notification that signifies the message; and
perform a write to the memory address to cause the snoop notification to communicate the message.

2. The apparatus of claim 1, wherein information written to the memory address is not pertinent to the message.

3. The apparatus of claim 1, the logic to further perform determination of message payload information, wherein performance of the write to the memory address comprises performance of the write of the message payload information to the memory address.

4. The apparatus of claim 1, the logic to further perform:
determination to send another message, such that the other message is received subsequent to the message;
determination of another memory address to trigger a snoop notification that signifies the other message;
receipt of a snoop notification associated with the memory address; and
performance of a write to the other memory address to cause the snoop notification to communicate the other message, based at least in part on receipt of the snoop notification associated with the memory address.

5. An apparatus comprising:
logic to:
receive, at a device, a snoop notification indicating a write to a memory address associated with a cache;
determine that the snoop notification signifies receipt of a message based, at least in part, on the memory address; and
perform an operation based, at least in part, on the message.

6. The apparatus of claim 5, the logic to further perform causation of a subsequent snoop notification based, at least in part, on determination that the snoop notification signifies the message.

7. The apparatus of claim 6, wherein causation of enablement of subsequent snoop notifications comprises performing a read of the memory address.

8. The apparatus of claim 5, wherein receipt of the snoop notification is performed by a monitoring agent.

9. The apparatus of claim 5, the logic to further perform receipt of message memory allocation information, wherein determination that the snoop notification denotes receipt of the message is further based, at least in part, on correlation between the memory address and the message memory allocation information.

10. The apparatus of claim 5, wherein the operation is based, at least in part, on the message without regard for information stored at the memory address.

11. An apparatus comprising:
a system on a chip including:
an integrated accelerator device;
a cache memory; and
a processing element to perform:
receipt of a snoop notification indicating a write to a memory address, by a central processing unit, associated with a cache;
determination that the snoop notification signifies receipt of a message based, at least in part, on the memory address; and
performance of an operation based, at least in part, on the message.

12. The apparatus of claim 11, the integrated accelerator device comprising logic to perform causation of enablement of a subsequent snoop notification based, at least in part, on determination that the snoop notification signifies the message.

13. The apparatus of claim 11, the central processing unit is a central processing unit and the integrated accelerator device is at least one of an embedded controller or a device.

14. The apparatus of claim 11, wherein the receipt of the snoop notification is performed by a monitoring agent.

15. The apparatus of claim 11, the integrated accelerator device comprising logic to perform receipt of message memory allocation information from the central processing unit, wherein determination that the snoop notification denotes receipt of the message is further based, at least in part, on correlation between the memory address and the message memory allocation information.

16. The apparatus of claim 11, wherein the operation is based, at least in part, on the message without regard for information stored at the memory address.

17. The apparatus of claim 11, wherein the central processing unit comprises:
a cache memory; and
a processing element to perform:
determination to send a message to the integrated accelerator device;
determination of a memory address to trigger a snoop notification that signifies the message; and
performance of a write to the memory address to cause the snoop notification to communicate the message to the integrated accelerator device.

18. The apparatus of claim 17, wherein information written to the memory address is not pertinent to the message.

19. The apparatus of claim 17, the central processing unit comprising logic to perform determination of message payload information, wherein performance of the write to the memory address comprises performance of the write of the message payload information to the memory address.

20. The apparatus of claim 17, the central processing unit comprising logic to perform:
determination to send another message to the integrated accelerator device, such that the other message is received by the integrated accelerator device subsequent to the message;
determination of another memory address to trigger a snoop notification that signifies the other message;
receipt of a snoop notification associated with the memory address; and
performance of a write to the other memory address to cause the snoop notification to communicate the other message to the integrated accelerator device, based at least in part on receipt of the snoop notification associated with the memory address.

21. The apparatus of claim 17, the central processing unit comprising logic to perform:
receipt of a snoop notification indicating a write to a memory address associated with a cache;
determination that the snoop notification signifies receipt of a message by the integrated accelerator device based, at least in part, on the memory address; and
performance of an operation based, at least in part, on the message.

22. The apparatus of claim 11, further comprising memory external to the system-on-chip.

23. The apparatus of claim 11, wherein the apparatus is a computing system that comprises the system on a chip.

24. A method comprising:
receiving a snoop notification indicating a write to a memory address associated with a cache;
determining that the snoop notification signifies receipt of a message based, at least in part, on the memory address; and
performing an operation based, at least in part, on the message.

25. The method of claim 24, further comprising causation of enablement of a subsequent snoop notification based, at least in part, on determination that the snoop notification signifies the message.
